(19) United States
(12) Patent Application Publication
(10) Pub. No.: US 2026/0278989 A1
(43) Pub. Date: Sep. 17, 2026

(54) System, use and method for user guidance and/or user interaction of a user with objects in an industrial plant

(71) Applicant: SICK AG, Waldkirch (DE)

(72) Inventors: Boris BALDISCHWEILER, Reute (DE); Jens GEBAUER, Emmendingen (DE)

(21) Appl. No.: 19/557,465

(22) Filed: Mar. 5, 2026

(30) Foreign Application Priority Data
Mar. 11, 2025 (DE) 102025109178.1

(51) Int. Cl. G06V 10/20; G02B 27/01; G06F 3/01

(52) U.S. Cl. CPC G06V 10/255; G02B 27/0101; G06F 3/013; G02B 2027/0141

(57) ABSTRACT

A system for user guidance and/or user interaction with at least one object in an industrial plant includes a user interface and at least one environmental sensor to detect an environment of the user. The environmental sensor detects at least a part of the user's field of view to obtain data about an object in the environment. The system further includes at least one eye-tracking sensor to detect the gaze of the user and obtain eye-tracking data, and a processing device configured to determine a distance, position, direction of movement and/or speed of the object based on the obtained data about the object, to determine a parameter for the attention of the user to the object based on the eye-tracking data, to recognize a dangerous state based on the determined parameter and the determined data of the object, and to output a signal in response to the dangerous state recognition.

The invention relates to a system, a use of a system and a method for user guidance of a user in an industrial plant and/or for user interaction of the user with at least one object in the industrial plant.

Users can be present together with objects, for example with autonomous mobile (industrial) robots (AMRs) and/or automated guided vehicles (AGVs), in the same regions in an industrial plant and/or can work together with said objects. This poses challenges both in terms of personal protection (e.g. avoiding collisions between the objects and the user) and efficiency since unwanted downtimes of the objects (e.g. caused by an emergency stop of the object triggered by a detection of a protected field infringement of at least one safety sensor on the object) should be avoided as far as possible. An industrial plant can, for example, be a warehouse, a production hall, a chemical industry plant, a food industry plant, an animal husbandry plant or a power generation plant.

The user or the worker often carries out demanding activities in the industrial plant. In this respect, it can occur that the user mentally or cognitively focuses heavily on the activity currently performed by the user. Furthermore, the sensory perception range of the user can, for example, be limited by a limitation of the field of view, by wavelengths outside the visible range, and by noises below the perception limit or outside the perceptible frequency range. Both phenomena entail the risk that the user does not perceive objects in his environment (in good time), which can, however, be relevant to safety, such as the perception of an approaching AMR or AGV on a collision course.

The invention is based on the object of improving the human-machine interaction of a user with objects in an industrial plant.

A system having the features of claim 1 is provided for satisfying the object.

The system according to the invention for user guidance of a user in an industrial plant and/or for user interaction of the user with at least one object in the industrial plant comprises a user interface and at least one environmental sensor that is configured to detect an environment of the user in an industrial plant, wherein the environmental sensor detects at least a part of the field of view of the user, and to obtain data about the environment of the user in so doing, in particular data about the object in the environment of the user. The system further comprises at least one eye-tracking sensor that is configured to detect the gaze of the user and to obtain eye-tracking data in so doing. The system further comprises a processing device that is configured to determine a distance, a position, a direction of movement and/or a speed of the object based on the obtained data about the object, to determine a parameter for the attention of the user to the object based on the obtained eye-tracking data, to recognize a dangerous state based on the determined parameter for the attention of the user to the object and based on the determined distance of the object, based on the determined position of the object, based on the determined direction of movement of the object and/or based on the determined speed of the object, and to cause the user interface to output a signal, in particular a safety-related signal, in response to the recognition of the dangerous state.

In short, the invention is based on the idea of determining, by means of the detection of the environment and the gaze of the user, the movement of the object and the attention of the user to the object and, based on this, of providing a feedback mechanism for the indications and information (in particular the amount of information) output to the user and/or the control of the object. A guided perception of the object can be realized, which can support the user in his work process and can increase the efficiency of the work processes overall. In this way, human-machine interaction can be monitored and/or can be made more efficient and/or safer.

By means of the eye-tracking sensor, it can be determined more precisely where the user has placed his visual focus and whether he has probably recognized or perceived possible sources of danger, such as an approaching AMR or AGV. In the case of a non-recognition, the user can be made aware of the danger or the approaching object visually, haptically or acoustically. For example, it can be evaluated whether the user has consciously perceived the object that is on a collision course. If this is not the case, the attention of the user can be specifically drawn to the object, for example, by displaying a warning message in the field of vision and/or field of view of the user by means of the user interface. If the user then turns his head towards the object, the object can, for example, be highlighted with a red border for the user in a view generated by the user interface. Alternatively or additionally, the time until the collision can, for example, be displayed. Such a visual warning can, for example, be reinforced by acoustic and/or haptic signals. It can thus be made possible for the user to recognize the object in good time.

The signal, in particular a safety-related signal, can comprise a visual, haptic and/or acoustic signal, in particular a warning signal. Alternatively or additionally, the signal can comprise an action recommendation. Alternatively or additionally, the signal can comprise or trigger the adaptation of information displayed to the user. For example, a warning message displayed to the user can be enlarged and/or displayed in a different color in response to the outputting of the signal. In addition or alternatively, other displayed information can be removed and/or new information can be added. In particular, displayed information that is not acutely important, such as displayed meta information or assistance or instructions for the activity performed by the user, can be hidden in order not to bind the attention of the user. The signal, in particular the warning message, can comprise at least one geometric shape (e.g. a triangle), at least one symbol (e.g. an exclamation mark), text, at least one arrow or the like. For example, an arrow directed towards the object and/or a border around the object can be displayed to the user. Alternatively or additionally, the signal can comprise a control signal for the object, wherein the object is set into a safeguarded control mode in response to the reception of the control signal.

The object can, for example, comprise a manually controlled, semi-autonomously moving or autonomously moving industrial robot. The object can in particular comprise an AGV or AMR. Additionally or alternatively, the object can comprise another user. Additionally or alternatively, the object can comprise a protected field created in a safety sensor, wherein the safety sensor is attached to the industrial robot and can be moved along by it.

The system can comprise a system of sensors, for example at least one distance-measuring camera (e.g. stereoscopic or ToF), a high-resolution camera, a tracking camera directed into the environment, a camera for eye tracking, an infrared camera, a LiDAR scanner, a laser scanner, a flicker sensor, a radar sensor, an ultrasonic sensor, an environmental light sensor, a noise sensor, a microphone, and/or an inertial measurement unit (IMU).

The user interface can be configured to output information to the user. In particular, it is conceivable that the user interface can be configured to output information for user guidance to the user, which information, for example, serves as assistance or instructions for his performed activity.

The environmental sensor preferably detects at least a part of the field of view of the user, preferably the full field of view of the user. The environmental sensor preferably additionally detects at least a part outside the field of view of the user. The field of view of the user can refer to that region which the user can perceive without moving his eyes or head. The field of vision or field of view corresponds to the region which can be perceived by the user by additionally moving his eyes.

The environmental sensor can be aware of its orientation and/or position. The environmental sensor can be moved along with the head of the user so that the region of the environment that is detected by the environmental sensor preferably likewise changes with a changed field of view of the user.

The environmental sensor preferably comprises a 3D camera, a laser scanner, a LiDAR scanner, an ultrasonic sensor and/or a radar sensor.

The environmental sensor can comprise a light transmitter and a light receiver. Transmission light can be generated by the light transmitter coupled to and/or controlled by the light receiver and can be transmitted into the environment, in particular in the form of at least one monitoring and/or measuring beam. The light receiver can receive transmission light remitted by the environment (in particular by objects in the environment) as reception light and can measure data about the environment, in particular from objects in the environment, based on the received reception light by means of time-of-flight methods.

The data about the environment of the user obtained by means of the environmental sensor, in particular the data about the object in the environment of the user, can comprise distance values and intensity values. The distance values can specify a distance relative to the environmental sensor or can be converted into coordinate values in a global coordinate system. The distance values relative to the environmental sensor can substantially be viewed as distance values relative to the user. The data about the environment of the user can additionally also comprise speed values.

The gaze of the user can refer to his direction of gaze and/or focus. The parameter for the attention of the user to the object can specify a measure of a probability that the user has perceived the object. The parameter for the attention can comprise a fixation duration, number of fixations and/or time until the first fixation.

The processing device can comprise a processor, a microprocessor, a neural processor unit (NPU) or the like. Additionally or alternatively, the processing device can be connected to a remote server, wherein the remote server can take over some or all of the functions of the processing device. The processing device can be aware of its own position, the position of the environmental sensor and/or the position of the eye-tracking sensor (in a global coordinate system or relative to a component of the system).

In a further step, it can be determined by means of sensors of the system whether the user has reacted to the output of the signal (for example, by the user taking a sideways step). If such a reaction cannot be detected, a further signal, in particular a safety-related signal, can be output. For example, warning messages can be repeated and/or increased in their intensity.

According to one embodiment, the dangerous condition is recognized in that the parameter for the attention of the user to the object is equal to or less than an attention threshold value and the object is located in a safety zone created around the user, moves into the safety zone or will move into the safety zone within a certain time period, has a distance from the user equal to or less than a distance threshold value or will have a distance from the user equal to or less than the distance threshold value within a certain time period, has a speed equal to or greater than a speed threshold value, and/or has a direction of movement directed towards the user.

The attention threshold value can, for example, comprise a fixation duration threshold value, wherein the fixation duration threshold value can preferably have a value between 50 ms and 2 s, preferably between 200 ms and 600 ms. Advantageously, the attention threshold value can be taught individually for each user. During a fixation, the user can only perceive a limited region of his field of view. After a restriction of the field of view during a fixation, the field of view can only be fully scanned again by saccadic movements of the eyes in order to perceive dangers. This can be particularly relevant if the user focuses his attention on certain objects while carrying out an activity. An impairment of the attention of the user, such as the restriction of the field of view during the fixation, can be considered by the system via a suitable selection of the attention limit value, in particular the fixation duration limit value, so that, for example, the dangerous state is recognized sooner.

According to one embodiment, the signal that is output to the user is or will be adapted in dependence on the determined parameter for the attention of the user, the determined distance of the object, the determined position of the object, the determined direction of movement of the object and/or the determined speed of the object. For example, if the parameter for the attention is within a certain value range, the warning message can be displayed in a certain size (e.g. enlarged or reduced), the warning message can be displayed in a certain color (e.g. yellow, orange or red), the warning message can be output with or without an acoustic and/or haptic signal and/or the warning message can be output with or without setting the object into a safeguarded control mode. The same can apply to the determined distance, the determined position, the determined direction of movement and/or the determined speed. In this way, the reaction of the system, in particular the amount of information output to the user, can be dynamically adapted. The system can also allow the user to make a selection himself to a certain extent for the displayed information or the information to be displayed.

According to one embodiment, the processing device is configured to set the object into a safeguarded control mode in response to the recognition of the dangerous state. The safeguarded control mode can, for example, comprise a slowing down, a stopping of the machine, a changing of a route or a moving into a holding position.

Alternatively or additionally, the user interface can be configured to receive a command of the user. The object can, for example, be set into the safeguarded control mode in response to the reception of the command. The system (in particular the processing device and/or the user interface) and the object can be in a wireless or wired signal connection. The command can, for example, be entered as a voice command, as a gesture, as a touch, as the pressing of a button and/or as the operation of a touch field.

According to one embodiment, the environmental sensor can be moved along by the user.

The user interface can be configured to display at least a part of the environment to the user. The user interface can comprise a screen, a touchscreen and/or transparent glass.

According to one embodiment, the system comprises a head-mounted eye-tracking system.

According to one embodiment, the system comprises augmented reality glasses or virtual reality glasses. The user interface can be configured to display at least a part of the environment to the user in an augmented reality view or a virtual reality view.

According to one embodiment, the user interface comprises laser protection glasses. Objects that move autonomously in the industrial plant often comprise laser light-based sensors for an autonomous control. The laser protection glasses of the user interface can thus prevent damage to the eyes of the user who is in the same environment as such objects.

According to one embodiment, the environmental sensor comprises a safety sensor. In this way, the safety of the system can be increased. In this respect, the terms safe or safety used herein can be understood in the sense of certain safety-specific standards, such as ISO 13849, IEC 61508 or IEC 62998.

According to one embodiment, no safety sensor is attached to the object. With the procedures described herein, a safety class and/or safety level of the system can be increased to such an extent that a safety class and/or safety level can be achieved without having to use special safety sensors on the object. Thus, cost-intensive safety sensors on the object can be omitted.

According to one embodiment, the environmental sensor detects the full field of view of the user and additionally detects a region of the environment outside the field of view of the user. In this way, the system can alert the user to hazards that are outside the field of view of the user, whereby the perception range of the user can be effectively extended.

According to one embodiment, the safety-related signal comprises a visual, acoustic and/or haptic warning signal. The safety-related signal preferably comprises a push message.

According to one embodiment, the object comprises an industrial robot and at least one safety sensor, wherein a protected field is created in the safety sensor, wherein the safety sensor is attached to the industrial robot. An industrial robot can refer to an AMR or AGV. A further safety-related signal can be output in response to an infringement of the protected field. The safety sensor can be moved along by the industrial robot. According to the embodiment, the environmental sensor is configured to obtain data about the protected field, the user interface is configured to visualize the protected field for the user, preferably in an augmented reality view or virtual reality view (e.g. as at least one geometric shape and/or text display), based on the obtained data about the protected field, and the processing device is configured to determine a parameter for the attention of the user to the visualized protected field based on the obtained eye-tracking data, to determine a distance of the protected field, a position of the protected field, a direction of movement of the protected field and/or a speed of the protected field, and to recognize the dangerous state based on the determined parameter for the attention of the user to the visualized protected field and based on the determined distance of the protected field, based on the determined position of the protected field, based on the determined direction of movement of the protected field and/or based on the determined speed of the protected field. The processing device can be configured to determine the position of the industrial robot, the direction of movement of the industrial robot and/or the speed of the industrial robot based on the obtained data about the object. The processing device can be configured to determine the position of the protected field, the direction of movement of the protected field and/or the speed of the protected field based on the determined position of the industrial robot, the determined direction of movement of the industrial robot and/or the determined speed of the industrial robot. The environmental sensor can comprise a communication interface and can be in a wireless or wired signal connection with the safety sensor and/or with the industrial robot in order to receive and/or retrieve the data about the protected field (e.g. the position at the industrial robot, the orientation and/or the size of the protected field). Alternatively or additionally, the processing device can be configured to recognize a marking applied to the industrial robot and/or the safety sensor, such as an identifier and/or a OR code, in the data about the object obtained by means of the environmental sensor in order to obtain the information about the protected field. The processing device can, for example, retrieve the information about the protected field from a remote server based on the recognized identifier.

According to one embodiment, the user interface is configured to output a visual warning message to the user on the object and the processing device is configured to determine a parameter for the attention of the user to the visual warning message based on the obtained eye-tracking data, and to recognize the dangerous state based on the determined parameter for the attention of the user to the object, based on the determined parameter for the attention of the user to the visual warning message and based on the determined distance of the object, based on the determined position of the object, based on the determined direction of movement of the object and/or based on the determined speed of the object, wherein the processing device preferably causes the user interface to adapt the visual warning message in response to the recognition of the dangerous state. The visual warning message preferably indicates a protected field created in a safety sensor attached to the object. The visual warning message preferably comprises a visualization of the protected field in an augmented reality view or a virtual reality view.

According to one embodiment, the environmental sensor is configured to obtain data about at least one further object in the environment of the user; and the processing device is configured to determine a parameter for the attention of the user to the further object based on the obtained eye-tracking data and to cause the user interface to output a further signal, in particular instructions or information with respect to the further object, to the user based on the determined parameter for the attention of the user to the further object. For example, the eye-tracking function can also be used to intentionally display instructions or information about objects which the user has been looking at for a longer time period. For example, status information of an industrial robot can be displayed as an info window when viewed for a longer time period. In combination with the input of commands (e.g. gestures), an active control can also be realized. As a further example, it can be checked whether the user lets his gaze wander and is not (or no longer) focused on a workpiece, for example. If so, an instruction or information for the next activity step can be displayed by means of the user interface. Preferably, the further object comprises a safety sensor (or an industrial robot comprising a safety sensor) and the output information comprises information with respect to a protected field created in the safety sensor. The information with respect to the further object, in particular the protected field, can be output to the user, for example, as at least one geometric shape and/or text display visualized in an augmented reality view or a virtual reality view. As described herein, the information with respect to the further object can be obtained by means of a recognition of a marking and/or a retrieval via a communication interface. Alternatively or additionally, the information with respect to the further object can be pre-stored in the processing device. The further object can be attached in the environment in a stationary manner or can move in the environment. Alternatively or additionally, the information with respect to the further object can comprise information about the safety level of the safety sensor. For the implementation of a new application, new information about the further object can be flexibly learned by the system or entered into the system. In this way, a user guidance can be realized overall that can be flexibly adapted to new applications.

According to one embodiment, the processing device is configured to determine a parameter for the general attention of the user based on the eye-tracking data, and to cause the user interface to output a further signal, in particular a safety-related signal, to the user based on the determined parameter for the general attention of the user. For example, based on a movement pattern of the pupils of the user, it can be determined whether the user is tired and therefore less focused. By outputting the further safety-related signal, the attention of the user can be increased again, for example, by adjusting an amount of information displayed to the user and/or by outputting an additional message to the user that draws the attention of the user to his state of fatigue. The message can display a fatigue warning and/or the need for a break to the user. Algorithms for fatigue detection by means of eye tracking are generally known.

According to one embodiment, the processing device is configured to determine a parameter for the attention of the user to the object at specific time intervals, in particular regular time intervals, based on the eye-tracking data; based on the parameters for the attention of the user to the object that are determined at the specific time intervals and based on the determined distance of the object, based on the determined position of the object, based on the determined direction of movement of the object and/or based on the determined speed of the object, to make a prediction whether a parameter for the attention of the user to the object that is to be determined temporally prior to a pre-calculated possible collision between the user and the object will exceed an attention threshold value; and to recognize the dangerous state based on the prediction. In other words, the system can make a prediction as to how likely the user is to recognize the danger in his current state and can already alert the user to the danger at an early stage.

For example, a time development for the parameters for the attention of the user to the object that are determined at the specific time intervals can be tracked. If a stagnation or a downward trend (e.g. a gradient of a curve in a graph of the parameters plotted against time is close to zero or negative) can then be determined in the time development for the attention of the user to the object and, following the stagnation or the downward trend, it can be predicted that the parameter for the attention of the user to the object will not exceed the attention threshold value before the predicted collision (e.g. considering a time safety buffer), the negative prediction can be made that the user will not perceive the object in good time. The dangerous state is then recognized based on this negative prediction and the user can be made aware of the danger at an early stage. If, on the other hand, an upward trend (i.e. a gradient in the positive range) for the attention of the user to the object can be recognized in the time development and, following the upward trend, it can be predicted that the parameter for the attention of the user to the object will exceed the attention threshold value in good time before the predicted collision (e.g. considering the time safety buffer), the positive prediction can be made that the user will perceive the object in good time. In this case, there is no dangerous state. Additionally or alternatively, the system can be adapted to the respective user by machine learning.

According to one embodiment, the system comprises the object, in particular an industrial robot (e.g. an AMR or AGV).

The system can further comprise a communication interface for a communication with other systems in the industrial plant, in particular systems for user guidance and/or user interaction that are used by other users.

With the system described herein, a feedback mechanism can be provided in which an assessment takes place as to whether a danger has been and/or will be perceived by the user, in which a dynamic estimation of the environment or of objects in the environment is made and which enables as early as possible an intervention, which can subsequently increase the efficiency of the system overall with a simultaneous reduction of the accident risk. The system can open up possibilities for (machine) teaching for the individual user.

A further subject of the invention is a use of a system described herein for user guidance of a user in an industrial plant and/or for user interaction of the user with at least one object in the industrial plant.

A further subject of the invention is a method for user guidance of a user in an industrial plant and/or for user interaction of the user with at least one object in the industrial plant, said method comprising detecting an environment of the user in an industrial plant, wherein at least a part of the field of view of the user is detected and data about the environment of the user, in particular data about the object in the environment of the user, are obtained in so doing; detecting the gaze of the user by means of eye tracking, wherein eye-tracking data are obtained; determining a distance, a position, a direction of movement and/or a speed of the object based on the obtained data about the object; determining a parameter for the attention of the user to the object based on the obtained eye-tracking data; recognizing a dangerous state based on the determined parameter for the attention of the user to the object and based on the determined distance of the object, based on the determined position of the object, based on the determined direction of movement of the object and/or based on the determined speed of the object; and outputting a signal, in particular a safety-related signal, in response to the recognition of the dangerous state.

It is understood that what is described with respect to the system according to the invention also applies to the use of the system and to the method. This in particular applies to embodiments and advantages. Furthermore, it is to be understood that all the features and embodiments disclosed herein can be combined unless expressly stated otherwise.

The invention will be described in the following purely by way of example with reference to possible embodiments and to the enclosed drawing. There are shown:

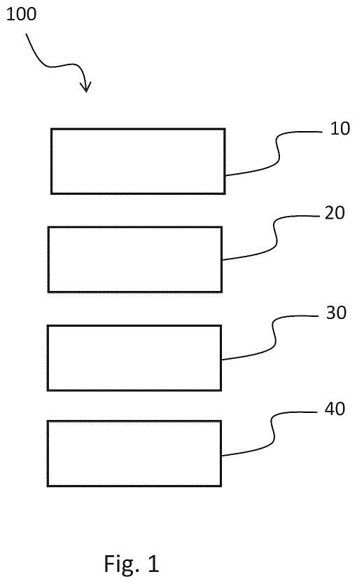

FIG. 1 a schematic representation of a system for user guidance of a user in an industrial plant and/or for user interaction of the user with at least one object in the industrial plant;

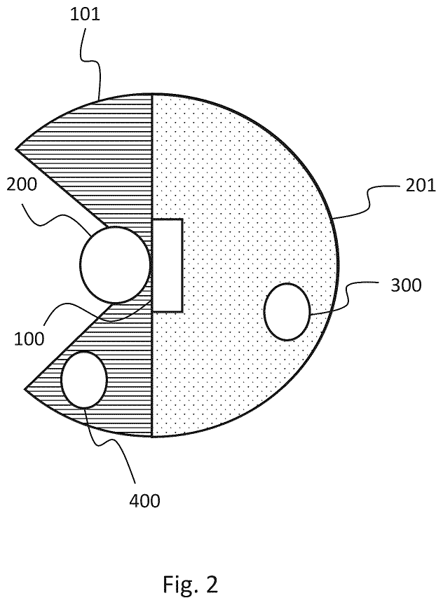

FIG. 2 a schematic representation of a system for user guidance of a user in an industrial plant and/or for user interaction of the user with at least one object in the industrial plant;

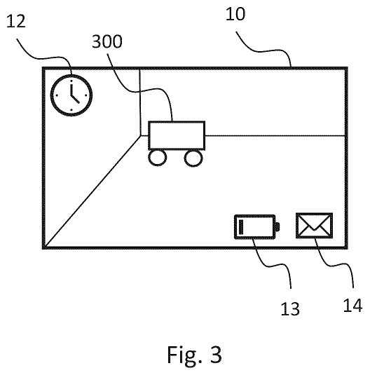

FIG. 3 a schematic representation of a virtual reality view of the environment displayed by the user interface of the system from FIG. 2;

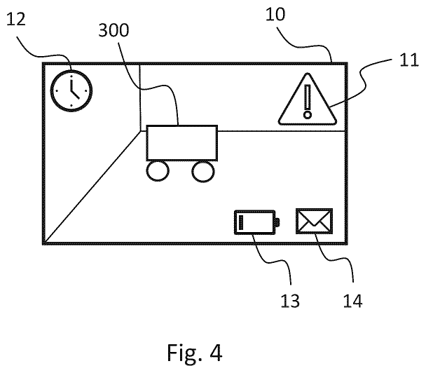

FIG. 4 a schematic representation of a safety-related signal output by the user interface;

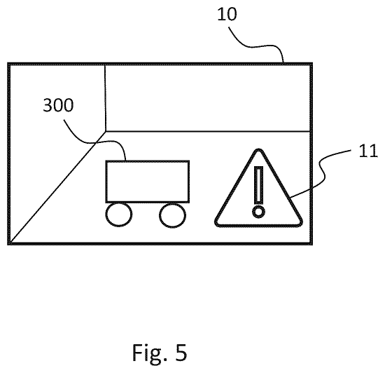

FIG. 5 a schematic representation of a safety-related signal output by the user interface;

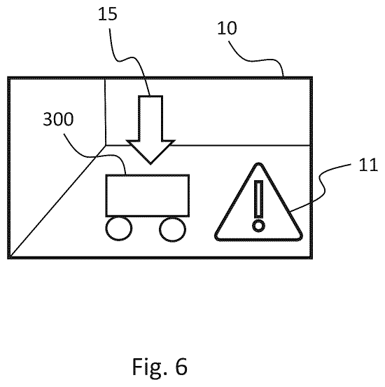

FIG. 6 a schematic representation of a safety-related signal output by the user interface; and

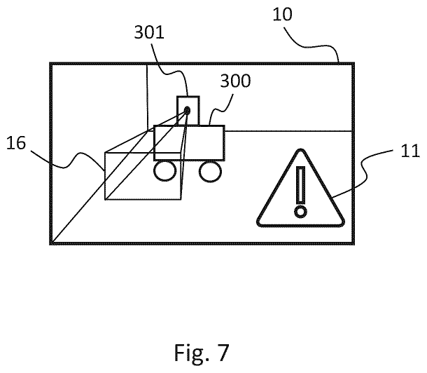

FIG. 7 a schematic representation of a safety-related signal output by the user interface.

FIG. 1 shows a system 100 for user guidance of a user in an industrial plant and/or for user interaction of the user with at least one object (not shown in FIG. 1) in the industrial plant. The system 100 comprises a user interface 10 that is configured to output information to the user. The system 100 further comprises at least one environmental sensor 20 that is configured to detect an environment of the user in an industrial plant, wherein the environmental sensor 20 detects at least a part of the field of view of the user, and to obtain data about the environment of the user in so doing, in particular data about the object in the environment of the user. The system 100 further comprises at least one eye-tracking sensor 30 that is configured to detect the gaze of the user and to obtain eye-tracking data in so doing. The system 100 further comprises a processing device 40 that is configured to determine a distance, a position, a direction of movement and/or a speed of the object based on the obtained data about the object, to determine a parameter for the attention of the user to the object based on the obtained eye-tracking data; to recognize a dangerous state based on the determined parameter for the attention of the user to the object and based on the determined distance of the object, based on the determined position of the object, based on the determined direction of movement of the object and/or based on the determined speed of the object; and to cause the user interface to output a safety-related signal in response to the recognition of the dangerous state. The user interface 10 can be configured to output a visual warning message to the user on the object.

Furthermore, it is conceivable that the user interface 10 is configured to provide further information for user guidance to the user that, for example, serves as assistance or instructions for the performed activity of the user. For example, the user interface 10 can display instructions to navigate the user to a specific position in the industrial plant, such as to a nearest maintenance location or a machine. Advantageously, a route can be used for the navigation that is not traveled by any object in a specific time window. Additionally or alternatively, the user interface 10 can display the instruction that the user should screw an M3 screw into a marked hole at a workpiece. The system 100 can check whether the correct screw is or has been screwed into the correct position. If so, the screw and/or the hole can be marked in a color, e.g. green, by means of the user interface 10. Both an instruction to the user and a monitoring of his activity can thereby be provided. The display of the information, in particular the frequency of the display of the information, can be advantageously adapted to the behavior of the user. For example, the system can detect that the user lets his gaze sweep in a searching manner over the workpiece. The next instruction for the next activity step can then be displayed by means of the user interface 10. For users who screw in the correct screws without any recognizable need for assistance, information can be displayed only in the event of an error (e.g. wrong screw, wrong hole).

As shown schematically in FIG. 2, the system 100 can comprise a head-mounted eye-tracking system or can be a head-mounted eye-tracking system. Preferably, the system 100 comprises virtual reality glasses that can be worn by the user 200 on their head. It is understood that, in the examples described here, augmented reality glasses or another device could also be used to represent augmented reality in each case.

The system shown in FIG. 2 can comprise the same or similar components as the system shown in FIG. 1. The environmental sensor of the system 100 in FIG. 2 can detect the full field of view 201 (e.g. an angular range of 180°) of the user 200 and additionally a region 101 outside the field of view of the user 201. In this way, as shown in FIG. 2, the system 100 can obtain both data about the object 300 in the field of view 201 of the user 200 and data about a further object 400 outside the field of view 201 of the user 200 and can accordingly output both a warning message with respect to the object 300 and a further warning message with respect to the further object 400 to the user 200. In this way, the perception range of the user 200 can be extended.

FIG. 3 shows a schematic representation of a virtual reality view of a part of the environment in the industrial plant, such as can be displayed to the user by the user interface 10 of the system from FIG. 2. As shown in FIG. 3, in the virtual reality view generated by the user interface 10, the user can be shown both the environment in which the object 300 (here as an example an AGV) can be located and certain general indications, such as an indication 12 of the time, an indication 13 of the charge state of the system (in particular the virtual reality glasses) and an indication 14 of a message received.

As shown in FIG. 4, the autonomously moving object 300 can approach the user, whereupon the system can detect the dangerous state (e.g. with an approach up to a distance limit value). The user interface 10 then outputs a warning message 11 on the object 300 in the virtual reality view to make the user aware of the danger or the object 300.

FIG. 5 and FIG. 6 each show an adaptation of the virtual reality view shown in FIG. 4. The processing device of the system can be configured to determine a parameter for the attention of the user to the visual warning message 11 based on the obtained eye-tracking data and to recognize the dangerous state based on the determined parameter for the attention of the user to the object 300, based on the determined parameter for the attention of the user to the visual warning message 11 and based on the determined distance of the object 300, based on the determined position of the object 300, based on the determined direction of movement of the object and/or based on the determined speed of the object. The processing device can then cause the user interface 10 to adjust the visual warning message 11 in response to the recognition of the dangerous state. As shown in FIG. 5 and FIG. 6, the warning message can be enlarged and/or displayed at a different position in the virtual reality view. In addition, the other information 12, 13, 14 can be hidden. Furthermore, at least one further warning message 15 can be displayed on the object 300, such as an arrow directed towards the object 300 in FIG. 6. It is understood that, in addition to the visual warning message 11, acoustic and/or haptic warning signals can also be output to the user.

As shown in FIG. 7, a visualization of a protected field 16, which is created in a safety sensor 301 attached to the object 300, can also be displayed to the user. As described for FIG. 5 and FIG. 6, a parameter for the attention of the user to the visualized protected field 16 (as shown in FIG. 7) can be determined by the system and can be considered in the recognition of the dangerous state.

Reference numeral list

| | |
|---|---|
| 10 | user interface |
| 20 | environmental sensor |
| 30 | eye-tracking sensor |
| 40 | processing device |
| 11 | visual warning message |
| 12 | indication of the time |
| 13 | indication of the charge state |
| 14 | indication of a message received |
| 15 | further warning message |
| 16 | visualized protected field |
| 100 | system |
| 101 | region outside the field of view of the user |
| 200 | user |
| 201 | field of view of the user |
| 300 | object |
| 301 | safety sensor |
| 400 | further object |

1. A system for user guidance of a user in an industrial plant and/or for user interaction of the user with at least one object in the industrial plant, said system comprising
a user interface;
at least one environmental sensor that is configured to detect an environment of the user in an industrial plant, wherein the environmental sensor detects at least a part of the field of view of the user, and to obtain data about the environment of the user in so doing;
at least one eye-tracking sensor that is configured to detect the gaze of the user and to obtain eye-tracking data in so doing; and
a processing device that is configured
to determine a distance, a position, a direction of movement and/or a speed of the object based on the obtained data about the object,
to determine a parameter for the attention of the user to the object based on the obtained eye-tracking data,
to recognize a dangerous state based on the determined parameter for the attention of the user to the object and based on the determined distance of the object, based on the determined position of the object, based on the determined direction of movement of the object and/or based on the determined speed of the object, and
to cause the user interface to output a signal in response to the recognition of the dangerous state.

2. The system according to claim 1, wherein the dangerous state is recognized in that the parameter for the attention of the user to the object is equal to or less than an attention threshold value and the object is located in a safety zone created around the user, moves into the safety zone or will move into the safety zone within a certain time period, has a distance from the user equal to or less than a distance threshold value or will have a distance from the user equal to or less than the distance threshold value within a certain time period, has a speed equal to or greater than a speed threshold value, and/or has a direction of movement directed towards the user.

3. The system according to claim 1, wherein the signal that is output to the user is or will be adapted in dependence on the determined parameter for the attention of the user, the determined distance of the object, the determined position of the object, the determined direction of movement of the object and/or the determined speed of the object.

4. The system according to claim 1,
wherein the processing device is configured to set the object into a safeguarded control mode in response to the recognition of the dangerous state; and/or
wherein the user interface is configured to receive a command of the user, wherein the object is set into the safeguarded control mode in response to the reception of the command.

5. The system according to claim 1,
wherein the environmental sensor can be moved along by the user; and/or
wherein the system comprises augmented reality glasses or virtual reality glasses.

6. The system according to claim 1,
wherein the user interface comprises laser protection glasses;
wherein the environmental sensor comprises a safety sensor; and/or
wherein no safety sensor is attached to the object.

7. The system according to claim 1, wherein the environmental sensor detects the full field of view of the user and additionally detects a region of the environment outside the field of view of the user.

8. The system according to claim 1, wherein the signal is a safety related signal and wherein the safety-related signal comprises a visual, acoustic and/or haptic warning signal.

9. The system according to claim 1,
wherein the object comprises an industrial robot and at least one safety sensor, wherein a protected field is created in the safety sensor, wherein the safety sensor is attached to the industrial robot;
wherein the environmental sensor is configured to obtain data about the protected field,
wherein the user interface is configured to visualize the protected field for the user based on the obtained data about the protected field, and
wherein the processing device is configured
to determine a parameter for the attention of the user to the visualized protected field based on the obtained eye-tracking data;
to determine a distance of the protected field, a position of the protected field, a direction of movement of the protected field and/or a speed of the protected field; and
to recognize the dangerous state based on the determined parameter for the attention of the user to the visualized protected field and based on the determined distance of the protected field, based on the determined position of the protected field, based on the determined direction of movement of the protected field and/or based on the determined speed of the protected field.

10. The system according to claim 1,
wherein the user interface is configured to output a visual warning message to the user on the object; and
wherein the processing device is configured
to determine a parameter for the attention of the user to the visual warning message based on the obtained eye-tracking data, and
to recognize the dangerous state based on the determined parameter for the attention of the user to the object, based on the determined parameter for the attention of the user to the visual warning message and based on the determined distance of the object, based on the determined position of the object, based on the determined direction of movement of the object and/or based on the determined speed of the object.

11. The system according to claim 1,
wherein the environmental sensor is configured to obtain data about at least one further object in the environment of the user; and
wherein the processing device is configured to determine a parameter for the attention of the user to the further object based on the obtained eye-tracking data and to cause the user interface to output a further signal to the user based on the determined parameter for the attention of the user to the further object.

12. The system according to claim 1,
wherein the processing device is configured
to determine a parameter for the general attention of the user based on the eye-tracking data, and
to cause the user interface to output a further signal to the user based on the determined parameter for the general attention of the user.

13. The system according to claim 1, wherein the processing device is configured
to determine a parameter for the attention of the user to the object at specific time intervals based on the eye-tracking data,
based on the parameters for the attention of the user to the object that are determined at the specific time intervals and based on the determined distance of the object, based on the determined position of the object, based on the determined direction of movement of the object and/or based on the determined speed of the object, to make a prediction whether a parameter for the attention of the user to the object that is to be determined temporally prior to a pre-calculated possible collision between the user and the object will exceed an attention threshold value, and
to recognize the dangerous state based on the prediction.

14. A method of using a system according to claim 1 for user guidance of a user in an industrial plant and/or for user interaction of the user with at least one object in the industrial plant.

15. A method for user guidance of a user in an industrial plant and/or for user interaction of the user with at least one object in the industrial plant, said method comprising
detecting an environment of the user in an industrial plant, wherein at least a part of the field of view of the user is detected and data about the environment of the user are obtained in so doing;
detecting the gaze of the user by means of eye tracking, wherein eye-tracking data are obtained;
determining a distance, a position, a direction of movement and/or a speed of the object based on the obtained data about the object;
determining a parameter for the attention of the user to the object based on the obtained eye-tracking data;
recognizing a dangerous state based on the determined parameter for the attention of the user to the object and based on the determined distance of the object, based on the determined position of the object, based on the determined direction of movement of the object and/or based on the determined speed of the object; and
outputting a signal in response to the recognition of the dangerous state.

16. The system according to claim 1 wherein the data about the environment of the user is data about an object in the environment of the user.

17. The system according to claim 1 wherein the signal is a safety-related signal.

18. The system according to claim 5,
wherein the system comprises a head-mounted eye-tracking system.

19. The system according to claim 10,
wherein the visual warning message indicates a protected field created in a safety sensor attached to the object.

20. The system according to claim 10,
wherein the processing device causes the user interface to adapt the visual warning message in response to the recognition of the dangerous state.

21. The system according to claim 11,
wherein the further object comprises a safety sensor and the output information comprises information with respect to a protected field created in the safety sensor.
